(19) United States
(12) Patent Application Publication
(10) Pub. No.: US 2002/0166305 A1
(43) Pub. Date: Nov. 14, 2002

(54) Slide-out edge protector

(76) Inventor: Ron Weller, La Mesa, CA (US)

Correspondence Address: Steven W. Webb, Law Offices of Steven W. Webb, 655 Second Street, Encinitas, CA, 92024, US

(21) Appl. No.: 09/853,780

(22) Filed: May 14, 2001

(51) Int. Cl. E04C 2/38; B44F 9/00; B44F 7/00

(52) U.S. Cl. 52/658; 52/716.8; 52/656.1; 52/312; 52/716.1

(57) ABSTRACT

A protective cylindrical sleeve for the metal corners of recreational vehicle slide-outs is disclosed, where the sleeve is inexpensive to manufacture and easy to attach and remove. The sleeve can be made out of a solid or composite material.

### FIELD OF THE INVENTION

The present invention relates to the field of recreational vehicle accessories. More specifically, the present invention pertains to the development of aftermarket supplies to improve the utility and safety of slide-out campers and shells.

The slide-out edge protector is a bumper molded from soft foam plastic in such a manner as to provide a sleeve that fits removably over the corner edges of recreational vehicle slide-outs, and thereby protects persons from encountering the unprotected corner edge. Because of the typical height above ground of the bottom corner of said slide-outs, children are particularly likely to encounter the hard points of the corner.

The present invention is particularly useful for protecting recreational vehicle users from encountering the sharp metal edges of camper and fifth-wheel slide-outs. Current after-market camper supplies and mechanisms do not address this problem.

### BACKGROUND OF THE INVENTION

Recreational vehicle slide-outs are made of metal and have several sharp edges and corners, which are easily encountered accidentally by the users of these vehicles. Moldings to protect persons from encountering sharp edges have been developed for other applications.

For example, U.S. Pat. No. 6,044,601 teaches an adhesively attached molding for structural forms in houses, such as the edges of walls and the like. This molding is described as covering and protecting a 90 degree angle corner.

U.S. Pat. No. 5,904,406 teaches a foam headrest that snaps over the tops of lawn or beach chairs. It possesses a circular slit channel to fit over the tubular tops of said chairs.

U.S. Pat. No. 5,639,072 describes an edge protector for furniture that uses velcro fasteners to hold it to furniture. It covers a 270 degree arc of the edge of the furniture to be protected. Another embodiment of this invention teaches a bumper that encloses a furniture edge, using fasteners to attach it removably.

Based on the above, there is obviously a need for a protective bumper for dangerous metal edges of vehicles around which many persons will be moving, playing, and working. Preventing injuries from encountering these corners and edges is the purpose of this invention.

### SUMMARY OF THE INVENTION

It is an object of this invention to provide a bumper to protect the dangerous metallic edges and corners of recreational vehicle slide-outs.

It is a further object of this invention to provide an inexpensively-manufactured, low-retail-cost protective bumper.

It is a further object of this invention that said bumper be made of durable foam plastic suitable for outdoor use on a recreational vehicle.

It is a further object of this invention that said bumper be easily attached and removed from slide-out edges and corners and have a simple attachment mechanism.

### BRIEF DESCRIPTION OF THE DRAWINGS

FIG. 1 is a perspective view of a typical slide-out with the invention attached to the lower corners

FIG. 2 is a side view of the invention

FIG. 3 is a cut-away view of the invention showing the interior channel and slit for attachment

FIG. 4 is a cut-away view showing the invention attached to an edge by means of the attachment slit

### DESCRIPTION OF THE PREFERRED EMBODIMENT

The present inventor has experimented with several edge protection systems for recreational vehicles using extruded foam. Edge protectors that are not inexpensive and are not easy to attach and remove are not desirable to use.

The best combination of features discovered by this inventor include durability, ease of attachment and removal, and low cost. Since this invention is easy to lose or accidentally discard, it must not be too expensive to replace. Since it will be used outside, it has to be durable and resistant to sun and rain.

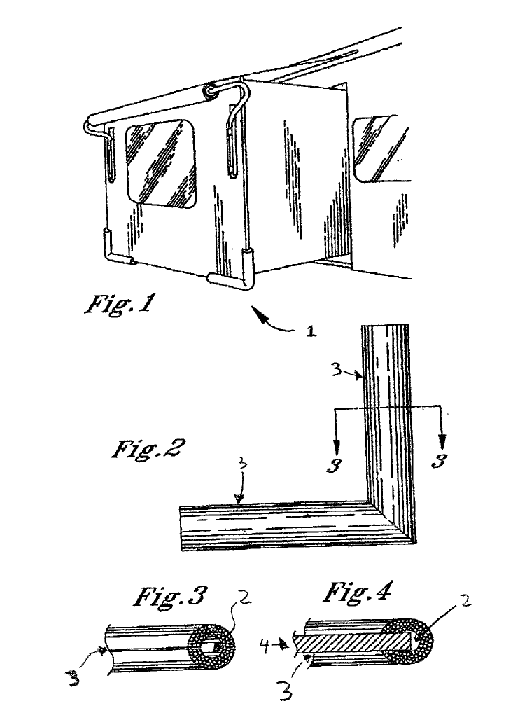

This invention is designed to be held on to the edges of recreational vehicle slide-outs by friction. FIG. 1 shows the slide-out protector 1 attached to a slide-out at both lower corners. FIG. 2 shows a side view of the slide-out protector 1 displaying the location of the attachment slit 3. FIG. 3 displays the internal channel 2 which runs the length of the invention and makes it a hollow tube, and the attachment slit 3, which connects the outer surface of the invention to the internal channel 2. The attachment slit 3 runs the entire length of the invention on the interior angle, as shown in FIG. 2. FIG. 4 displays the invention attached to an edge 4 by means of the attachment slit, which has been manually pulled apart so as to grip the edge. The attachment channel 2 is made of the same plastic foam as the body of the invention and its natural surface friction serves to hold the invention onto the edge or corner to which it is attached.

What is claimed is:

1. a protector for covering the corner formed by the sides of a metal sheet, said protector roughly cylindrical in shape, said protector possessing a cylindrical channel running its length down its geometrical center, said protector possessing a longitudinal slit from the exterior surface of said protector to the central cylindrical channel,
said protector bent in a right-angle roughly half way down its length,
said longitudinal slit positioned running the entire length of said protector on the interior angle of said right-angle bend,
said protector made out of a flexible material such that it can be easily bent by hand, and
said flexible material possessing a surface friction sufficient to support the weight of said protector when said attachment slit is engaged with a metal edge.

2. A protector as in claim 1 where said flexible material is a solid piece of plastic.

3. A protector as in claim 1 where said flexible material is made out of two layers of material,
said two layers of material comprising an external layer of material that comprises the external surface of said protector and an internal layer of material comprising the lining of said central cylindrical channel,
said external layer and said internal layer attached fixedly to each other the length of the invention.
